(19) United States
(12) Patent Application Publication
(10) Pub. No.: US 2020/0192513 A1
(43) Pub. Date: Jun. 18, 2020

(54) TOUCH SCREEN AND METHOD FOR PREPARING THE SAME, AND DISPLAY DEVICE

(71) Applicant: Yungu (Gu'an) Technology Co., Ltd., Langfang (CN)

(72) Inventor: Zilin ZHOU, Langfang (CN)

(73) Assignee: Yungu (Gu'an) Technology Co., Ltd., Langfang (CN)

(21) Appl. No.: 16/797,204

(22) Filed: Feb. 21, 2020

Related U.S. Application Data
(63) Continuation of application No. PCT/CN2019/085138, filed on Apr. 30, 2019.

(30) Foreign Application Priority Data
Aug. 13, 2018 (CN) 201810916755.4

(51) Int. Cl. G06F 3/041

(52) U.S. Cl. CPC G06F 3/0412; G06F 2203/04103

(57) ABSTRACT

A touch screen includes at least one first substrate; and a buffer structure. The buffer structure is located on the at least one first substrate. The buffer structure has at least one protrusion, and the protrusion is made of an elastic material so that when the buffer structure is subjected to an impact force, the impact force is dispersed by deformation of the protrusion. By providing an elastic buffer structure having the protrusion on the first substrate of the touch screen, when the touch screen is subjected to the impact force, the protrusion may be deformed to disperse the impact force, thereby protecting the device.

### CROSS-REFERENCE TO ASSOCIATED APPLICATIONS

This application is a continuation of International Application No. PCT/CN2019/085138 filed on Apr. 30, 2019, which claims priority to Chinese patent application No. 201810916755.4 filed on Aug. 13, 2018. Both applications are incorporated herein by reference in their entireties.

### TECHNICAL FIELD

Embodiments of the present application relate to the field of electronic manufacturing technologies, in particular to a touch screen and a method for preparing the same, and a display device.

### BACKGROUND

In recent years, flexible touch screens have become more and more widely used in mobile phones and portable devices. However, impact resistance of touch screens still needs to be improved. For example, when the touch screens are hit by a heavy object, a hit region cannot be displayed in full color instantaneously, this is because stress concentration cannot be dispersed resulting in component damage at the moment when the touch screens are hit by the heavy object.

Therefore, there is a need for technologies that can improve the impact resistance of the touch screens and display devices.

### SUMMARY

In view of this, embodiments of the present application provide a touch screen and a method for preparing the same, and a display device, which may protect the display device by dispersing an impact force when the display device is subjected to the impact force.

A touch screen according to a first aspect of the present application includes at least one first substrate; and a buffer structure. The buffer structure is located on the at least one first substrate, the buffer structure has at least one protrusion, and the at least one protrusion is composed of an elastic material so that when the buffer structure is subjected to an impact force, the impact force is dispersed by deformation of the at least one protrusion.

In one embodiment of the present application, the touch screen further includes a liquid optical adhesive layer disposed on the at least one first substrate and configured to seal the buffer structure.

In one embodiment of the present application, the touch screen further includes a plurality of electronic components dispersedly disposed on the at least one first substrate. The at least one protrusion is located at a gap between adjacent electronic components of the plurality of electronic components, and a height of the at least one protrusion is greater than a height of the electronic components.

In one embodiment of the present application, the height of the at least one protrusion is 1.2 to 1.8 times the height of the electronic components.

In one embodiment of the present application, the height of the at least one protrusion is 1.5 times the height of the electronic components.

In one embodiment of the present application, the touch screen further includes a plurality of electronic components disposed on an upper surface of the at least one first substrate. The buffer structure is disposed on a lower surface of the at least one first substrate.

In one embodiment of the present application, the electronic components include a nano silver touch sensitive electronic component.

In one embodiment of the present application, the touch screen further includes a second substrate. The buffer structure is located between the at least one first substrate and the second substrate, or the buffer structure is located on one side of the at least one first substrate away from the second substrate.

In one embodiment of the present application, a shape of the at least one protrusion includes at least one of a circular truncated cone, a cylinder, and a hemisphere.

In one embodiment of the present application, the first substrate includes a composite layer composed of a silicon oxide layer and a polyimide layer.

In one embodiment of the present application, a protrusion shaped of the hemisphere among the at least one protrusion is connected with the first substrate through a circular cross section of the hemisphere.

In one embodiment of the present application, a bottom surface of a protrusion shaped of the circular truncated cone among the at least one protrusion is connected to the first substrate.

A display device according to a second aspect of the present application includes a light emitting layer; and a touch screen including at least one first substrate and a buffer structure. The buffer structure is located on the at least one first substrate, the buffer structure has at least one protrusion, and the at least one protrusion is composed of an elastic material so that when the buffer structure is subjected to an impact force, the impact force is dispersed by deformation of the at least one protrusion. The touch screen is disposed on the light emitting layer.

In one embodiment of the present application, the buffer structure is located between the at least one first substrate and the light emitting layer.

A method for preparing a touch screen according to a third aspect of the present application includes providing a first substrate; forming an elastic material layer on the first substrate; and processing the elastic material layer into a buffer structure by a manner of photolithography or transfer. The buffer structure has a protrusion so that when the buffer structure is subjected to an impact force, the impact force is dispersed by deformation of the protrusion.

In one embodiment of the present application, the method further includes forming a liquid optical adhesive layer on the buffer structure to seal the buffer structure.

According to technical schemes provided by the embodiments of the present application, by providing the elastic buffer structure having the protrusion on the first substrate of the touch screen, when the touch screen is subjected to the impact force, the protrusion may be deformed to disperse the impact force, thereby protecting the device.

It should be understood that the above general descriptions and the following detailed descriptions are only exemplary and explanatory, and shall not limit the present application.

### BRIEF DESCRIPTION OF DRAWINGS

The accompanying drawings herein are incorporated into the specification and form part of the specification, and show embodiments in accordance with the present application, and are used together with the specification to explain the principles of the present application.

FIG. 1 is a schematic structural diagram of a touch screen according to an exemplary embodiment of the present application.

FIG. 2 is a schematic structural diagram of a touch screen according to another exemplary embodiment of the present application.

FIG. 3 is a schematic structural diagram of a touch screen according to still another exemplary embodiment of the present application.

FIG. 4 is a schematic block diagram of a display device according to an exemplary embodiment of the present application.

FIG. 5 is a schematic flowchart of a method for preparing a touch screen according to an exemplary embodiment of the present application.

### DETAILED DESCRIPTION

Technical schemes in embodiments of the present application will be clearly and completely described in the following with reference to the accompanying drawings in the embodiments.

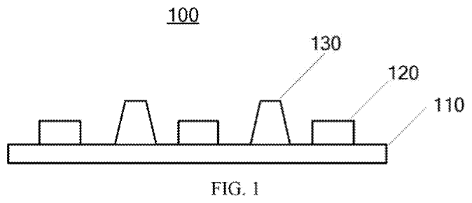

FIG. 1 is a schematic structural diagram of a touch screen 100 according to an exemplary embodiment of the present application. As shown in FIG. 1, the touch screen 100 includes at least one first substrate 110; and a buffer structure 130.

In the embodiment of the present application, the first substrate 110 is a structure configured to carry various elements in the touch screen 100, and is generally made of a transparent inert material. For example, in one embodiment of the present application, the first substrate 110 is made of silicon oxide. Optionally, the first substrate 110 is a composite structure in which a silicon oxide layer and a polyimide layer are bonded together. In still another embodiment of the present application, the first substrate 110 is composed of sapphire. The material of the first substrate 110 is not limited in the embodiment of the present application.

In the embodiment of the present application, electronic components 120 are provided on the first substrate 110. The electronic components 120 include various elements required to implement functions of the touch screen 100. For example, in one embodiment of the present application, the electronic components 120 include a nano silver touch sensitive electronic component. Optionally, the electronic components 120 include a micro-capacitor, a micro-inductance, and a circuit configured to connect the electronic component. A type and an arrangement of the electronic components 120 are not limited in the embodiment of the present application. The electronic components 120 may be formed on the first substrate 110 by etching or photolithography, which is not limited by the embodiment of the present application.

The buffer structure 130 is located on the first substrate 110, the buffer structure 130 has at least one protrusion, and each of the at least one protrusion is made of an elastic material, so that when the buffer structure 130 is subjected to an impact force, the impact force is dispersed by deformation of the protrusion.

The buffer structure 130 may be made of a material having elasticity. For example, the buffer structure 130 is made of photoresist, or silica gel. The specific components of the buffer structure are not limited in the embodiment of the present application.

The touch screen 100 further includes a plurality of electronic components dispersedly arranged. The buffer structure 130 may include a plurality of protrusions having a columnar shape and distributed at a gap between adjacent two electronic components 120. Optionally, the buffer structure 130 may include a plurality of protrusions, and the plurality of protrusions are strip-shaped and distributed in the gap between the two adjacent electronic components 120, which is not limited by the embodiment of the present application.

In one embodiment of the present application, a height of the protrusion is greater than a height of the electronic components.

The protrusion is provided with the height greater than that of the electronic components, so that when the touch screen is subjected to an impact force from a top of the electronic components, the protrusion would be deformed under the impact force, precede to the electronic components, thereby dispersing the impact force and protecting the electronic components.

In one embodiment of the present application, the height of the protrusion is 1.2 to 1.8 times the height of the electronic components; preferably, the height of the protrusion is 1.5 times the height of the electronic components.

When the height of the protrusion is 1.5 times the height of the electronic components, purposes of protecting the electronic component may be achieved, and the amount of materials constituting the buffer structure can also be saved.

Optionally, the touch screen 100 has a multi-layer structure. Each layer of the multi-layer structure has the first substrate 110, and the buffer structure 130 is disposed on one of the first substrate 110. As for the touch screen 100 having the multi-layer structure, the buffer structure 130 is not limited on which layer of the touch screen 100 (in the embodiment of the present application.

Optionally, an upper surface of the first substrate 110 is provided with the electronic components 120, and the buffer structure 130 is disposed on a lower surface of the first substrate 110.

Optionally, the buffer structure 130 includes one buffer layer and a protrusion disposed on the one buffer layer. The buffer layer is adhered to the lower surface of the first substrate 110, and the protrusion is dispersed in a columnar shape on the buffer layer. Optionally, the protrusion is dispersed in a strip shape on the buffer layer, and the specific shape of the protrusion is not limited in the embodiment of the present application.

According to the technical schemes provided by the embodiments of the present application, by providing the elastic buffer structure having the protrusion on the first substrate of the touch screen, when the touch screen is subjected to the impact force, the protrusion may be deformed to disperse the impact force, thereby protecting the device. In addition, a process is simple and an influence on yield is small, and a thickness of the screen after assembly is not significantly increased in the embodiments of the present application.

In one embodiment of the present application, a shape of the protrusion includes at least one of a circular truncated cone, a cylinder, and a hemisphere.

In the embodiment of the present application, the hemisphere includes at least one of a semi-ellipsoid or a semi-spherical ball. The protrusion shaped of the hemisphere is connected with the first substrate through a circular cross section of the hemisphere. Optionally, the shape of the protrusion is the circular truncated cone, and the bottom surface of the circular truncated cone is connected to the first substrate.

The protrusion shaped of the circular truncated cone, the cylinder, or the hemisphere may effectively disperse the impact force, and when the protrusion is processed by the photolithography or the etching, the process is relatively simple, thereby improving production efficiency.

In one embodiment of the present application, the above-described electronic components include a nano silver touch sensitive electronic component; and the above-described first substrate includes a composite layer including a silicon oxide layer and a polyimide layer.

As for the touch screen manufactured by using the nano silver touch sensitive electronic component and the composite layer made of the silicon oxide layer and the polyimide layer, the buffer structure with the protrusion is provided, so that when the touch screen is subjected to the impact force, the protrusion may be deformed to disperse the impact force, thereby protecting the device.

In one embodiment of the present application, the touch screen 100 further includes a liquid optical adhesive layer. The liquid optical adhesive layer is disposed on the first substrate and is configured to seal the buffer structure.

Liquid optical adhesive is a kind of special adhesive configured to bond transparent optical components (such as lens, etc.), which has characteristics of colorless and transparent, light transmittance over 90%, good bonding strength, curing at room temperature or medium temperature, and small curing shrinkage. Organic silica gel, acrylic resin, unsaturated polyester, polyurethane, epoxy resin and other adhesives may also be configured to bond the optical components. In the embodiment of the present application, the liquid optical adhesive is disposed on the buffer structure to wrap and seal the buffer structure.

The buffer structure is sealed by the liquid optical adhesive, so that the first substrate with the buffer structure may be bonded with other elements by the liquid optical adhesive, and gaps around the protrusions is filled with the liquid optical adhesive, which makes no gas inclusion in the touch screen, thereby improving product quality of the touch screen.

In one embodiment of the present application, the touch screen is applied to a display device, the display device also includes a light emitting layer, and the buffer structure is located between the first substrate and the light emitting layer.

FIG. 2 is a schematic structural diagram of a touch screen 200 according to another exemplary embodiment of the present application. As shown in FIG. 2, the touch screen 200 includes a first substrate 210, electronic components 220, a buffer structure 230, and a light emitting layer 240.

The light emitting layer 240 refers to an element in the touch screen 200 configured to emit light to display information and generally includes a light-emitting diode and a plurality of electronic components. The light emitting layer 240 is covered by the first substrate 210 provided with touch sensitive electronic components 220. In the embodiment of the present application, the buffer structure 230 is disposed between the first substrate 210 and the light emitting layer 240. The buffer structure 230 is made of a transparent adhesive layer. In the preparation of the buffer structure 230, the adhesive layer is firstly disposed on a lower surface of the first substrate 210, and then the adhesive layer is processed to form a protrusion by transfer printing to form the buffer structure 230.

The buffer structure 230 is provided on the lower surface of the first substrate 210, which enables the buffer structure 230 be manufactured by transfer print, thereby reducing the process difficulty and manufacturing cost.

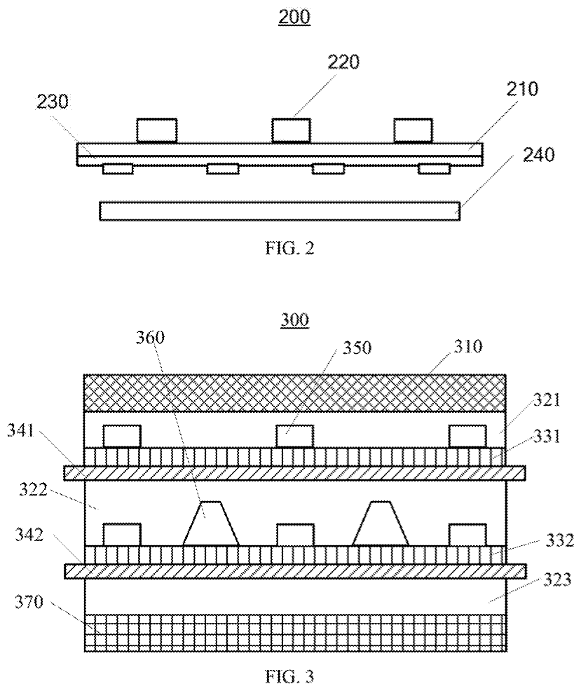

FIG. 3 is a schematic structural diagram of a touch screen 300 according to still another exemplary embodiment of the present application. As shown in FIG. 3, the touch screen 300 includes a cover plate 310, an optical adhesive layer 321, 322, and 323, silicon oxide first substrates 331 and 332, polyimide first substrates 341 and 342, electronic components 350, a buffer structure 360, and a light emitting layer 370.

In the embodiment of the present application, the touch screen 300 includes three functional layers. A lowermost functional layer of the three functional layers is the light emitting layer 370 configured to display various information. Generally, the light emitting layer 370 includes a light-emitting diode and a corresponding electronic component. The light emitting layer 370 is connected to the polyimide first substrate 342 over the light-emitting layer 370 via the optical adhesive layer 323. The optical adhesive layer 323 has high light transmittance and may bond the light emitting layer 370 and the polyimide first substrate 342 together.

In the embodiment of the present application, an intermediate functional layer of the three functional layers is located on an upper surface of the polyimide first substrate 342. The intermediate functional layer includes a silicon oxide layer 332 configured to carry touch sensitive electronic components. A buffer structure 360 is provided on an upper surface of the silicon oxide layer 332. The buffer structure 360 includes a plurality of elastic adhesive protrusions of a circular truncated cone shape are distributed in a gap among the touch sensitive electronic components. A height of the protrusion in the buffer structure 360 is greater than a height of the electronic components surrounding the protrusions, so that when the touch screen 300 is subjected to an impact force from above the touch screen 300, the protrusions would be deformed under the impact force, precede to the electronic components surrounding the protrusions. The impact force is then dispersed and the electronic components and the light emitting layer 370 are protected.

The silicon oxide layer 332 and the polyimide layer 341 are connected via the optical adhesive layer 322. The optical adhesive layer 322 fills the buffer structure 360 and the gaps around the electronic components, so that there is no bubble around the buffer structure 360 and the electronic components, which improves the quality of the touch screen 300.

An uppermost functional layer of the three functional layers is composed of the silicon oxide layer 331, the electronic components 350, and the optical adhesive layer 321. The uppermost functional layer has the same structure as the intermediate functional layer except that there is no the buffer structure 360, which will not be described again.

The uppermost functional layer is covered by the cover plate 310. The cover plate 310 is usually made of a material such as glass or plastic and configured to protect a structure under the cover plate.

In one embodiment of the present application, the touch screen 300 further includes a second substrate. The buffer structure is located between the first substrate and the second substrate; or the buffer structure is located on one side of the first substrate away from the second substrate.

Through the technical schemes provided by the embodiment of the present application, the touch screen with a double-layers structure may be provided with the buffer structure in any one of the layers, thus improving the impact resistance of the touch screen with the double-layers structure.

Another embodiment of the present application provides a display device, the display device includes a light emitting layer; the touch screen described in the above embodiments. The touch screen is disposed on the light emitting layer.

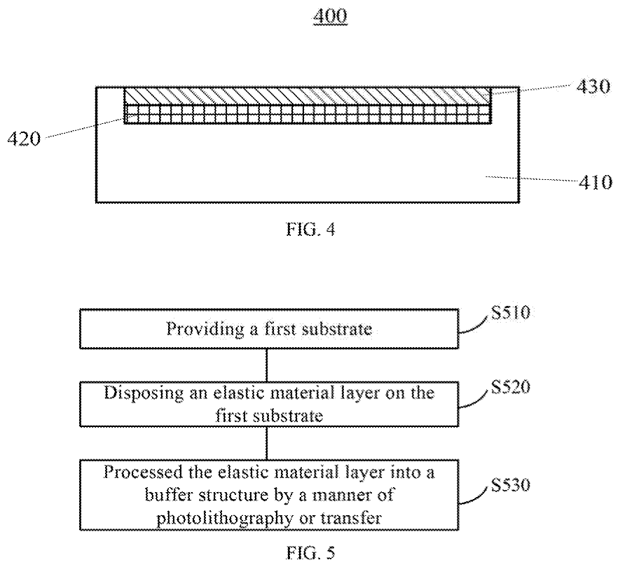

FIG. 4 is a schematic block diagram of a display device 400 according to an exemplary embodiment of the present application. As shown in FIG. 4, the display device 400 includes a body 410, a light emitting layer 420, and a touch screen 430.

In the embodiment of the present application, the body 410 of the display device 400 is configured to carry or accommodate various electronic devices. An upper surface of the body 410 is provided with the light emitting layer 420 configured to display various image information, and the light emitting layer 420 is covered with any one of the touch screens 430 in the above embodiments, so that a user may control the display device 400 by touching.

Any one of the touch screens 430 in the above embodiments is installed on the display device 400, so that when the light emitting layer 420 is subjected to an impact force, the impact force may be dispersed and buffered by the buffer structure in the touch screen 430, thereby protecting the light emitting layer 420.

FIG. 5 is a schematic flowchart of a method for preparing a touch screen according to an exemplary embodiment of the present application. The method for preparing the above touch screen includes the following steps.

S510: providing a first substrate.

S520: forming an elastic material layer on the first substrate. The first substrate is provided with a plurality of electronic components.

The elastic material layer is made of an adhesive having elasticity. For example, in the embodiment of the present application, the elastic material layer is made of photoresist, a plurality of electronic components are disposed on the first substrate, and the photoresist covers the plurality of electronic components and gaps between the plurality of electronic components. In another embodiment of the present application, the elastic material layer is composed of silica gel, and the specific components of the buffer structure are not limited in the embodiment of the present application.

S530: processing the elastic material layer into the buffer structure by photolithography or transfer print. The buffer structure has a protrusion so that when the buffer structure is subjected to an impact force, the impact force is dispersed by deformation of the protrusion.

Specifically, in one embodiment of the present application, the buffer structure is composed of photoresist, and a protrusion is prepared by photolithography.

First, one layer of the photoresist is disposed on the first substrate, and a surface of the electronic components and the first substrate is covered by the photoresist. Thereafter, a position of the protrusion to be prepared in the photoresist is blocked by setting a mask, and after the rest of the photoresist is exposed and removed, the protrusion is left to constitute the buffer structure.

In the embodiment of the present application, a pattern shape of the mask is controlled, so that the buffer structure includes a plurality of protrusions which are dispersed, and the plurality of protrusions are distributed at gaps between the electronic components. In another embodiment of the present application, a pattern shape of the mask is controlled, so that the protrusions are shaped of strip and distributed at the gaps between the electronic components. The specific shape and position of the protrusions are not limited in the embodiment of the present application.

In another embodiment of the present application, the buffer structure is made of transparent silica gel, and the protrusion is prepared by transfer print.

In the embodiment of the present application, an upper surface of the first substrate is provided with the electronic components. First, a transparent silica gel layer is coated on a lower surface of the first substrate, and the transparent silica gel layer is punched through a mold, so that the protrusion is prepared to form the buffer structure. A shape of the mold used in a transfer print process is controlled, so that the protrusions may be respectively formed into a columnar shape or a strip shape and dispersedly distributed. The specific shape of the protrusion is not limited in the embodiment of the present application.

According to the technical schemes provided by the embodiments of the present application, by providing an elastic buffer structure having a protrusion on the first substrate of the touch screen. When the touch screen is subjected to the impact force, the protrusion may be deformed to disperse the impact force, thereby protecting the device. In addition, a process is simple and an influence on yield is small, and a thickness of the screen after assembly is not significantly increased.

In one embodiment of the present application, the method for preparing the touch screen further includes: a liquid optical adhesive layer is prepared on the buffer structure to seal the buffer structure.

Liquid optical adhesive is a kind of special adhesive configured to bond transparent optical components (such as lens, etc.), which has characteristics of colorless and transparent, light transmittance over 90%, good bonding strength, curing at room temperature or medium temperature, and small curing shrinkage. Organic silica gel, acrylic resin, unsaturated polyester, polyurethane, epoxy resin and other adhesives may also be configured to bond optical components. In the embodiment of the present application, the liquid optical adhesive is disposed on the buffer structure to wrap and seal the buffer structure.

The buffer structure is sealed by the liquid optical adhesive, so that the first substrate with the buffer structure may be bonded with other elements by the liquid optical adhesive, and a gap around the protrusions is filled with the liquid optical adhesive, which makes no gas inclusion in the touch screen, thereby improving product quality of the touch screen.

After considering the specification and practicing the disclosure herein, those skilled in the art will easily come up with other embodiments of the present application. The purposes of the present application are to cover any variation, use or adaptation changes of the present application, which follows the general principles of the present application and includes common general knowledge or frequently used technical means in the technical field not disclosed in the present application. The description and the embodiments are only regarded as exemplary, and the true scope and spirit of the present application are indicated by the above claims.

It should be understood that the present application is not limited to the precise structure described above and shown in the accompanying drawings, and various modifications and changes can be made without departing from its scope. The scope of this present application is limited only by the appended claims.

What is claimed is:

1. A touch screen, comprising:
at least one first substrate; and
a buffer structure located on the at least one first substrate, the buffer structure having at least one protrusion made from elastic material, so that when the buffer structure is subjected to an impact force, the at least one protrusion has a deformation to disperse the impact force.

2. The touch screen of claim 1, further comprising:
a liquid optical adhesive layer disposed on the at least one first substrate and configured to seal the buffer structure.

3. The touch screen of claim 1, further comprising:
a plurality of electronic components dispersedly disposed on the at least one first substrate,
wherein the at least one protrusion is located at a gap between adjacent two electronic components of the plurality of electronic components, and a height of the at least one protrusion is greater than a height of the electronic component.

4. The touch screen of claim 3, wherein the height of the at least one protrusion is 1.2 to 1.8 times the height of the electronic component.

5. The touch screen of claim 4, wherein the height of the at least one protrusion is 1.5 times the height of the electronic component.

6. The touch screen of claim 1, further comprising:
a plurality of electronic components disposed on an upper surface of the at least one first substrate,
wherein the buffer structure is disposed on a lower surface of the at least one first substrate.

7. The touch screen of claim 3, wherein the electronic components comprise a nano silver touch sensitive electronic component.

8. The touch screen of claim 1, further comprising:
a second substrate, wherein the buffer structure is located between the at least one first substrate and the second substrate, or the buffer structure is located on one side of the at least one first substrate away from the second substrate.

9. The touch screen of claim 1, wherein a shape of the at least one protrusion comprises at least one of a circular truncated cone, a cylinder, and a hemisphere.

10. The touch screen of claim 1, wherein the at least one first substrate comprises a composite layer comprising a silicon oxide layer and a polyimide layer.

11. The touch screen of claim 9, wherein a protrusion shaped of the hemisphere of the at least one protrusion is connected with the first substrate through a circular cross section of the hemisphere.

12. The touch screen of claim 9, wherein a bottom surface of a protrusion shaped of the circular truncated cone of the at least one protrusion is connected to the first substrate.

13. A display device, comprising:
a light emitting layer; and
a touch screen comprising at least one first substrate and a buffer structure, wherein the buffer structure is located on the at least one first substrate, the buffer structure has at least one protrusion made from an elastic material so that when the buffer structure is subjected to an impact force, the impact force is dispersed by a deformation of the at least one protrusion, the touch screen is disposed on the light emitting layer.

14. The display device of claim 13, wherein the buffer structure is located between the at least one first substrate and the light emitting layer.

15. A method for preparing a touch screen, comprising:
providing a first substrate;
forming an elastic material layer on the first substrate; and
processing the elastic material layer into a buffer structure by photolithography or transfer printing, wherein the buffer structure has a protrusion so that when the buffer structure is subjected to an impact force, the impact force is dispersed by deformation of the protrusion.

16. The method of claim 15, further comprising:
forming a liquid optical adhesive layer on the buffer structure to seal the buffer structure.
